(19) United States
(12) Patent Application Publication
(10) Pub. No.: US 2009/0202702 A1
(43) Pub. Date: Aug. 13, 2009

(54) APPARATUS AND METHOD FOR MIXING A POWDER WITH A LIQUID

(75) Inventors: Tamir Farber, Tel-Aviv (IL); Boaz Zimmerman, Tel-Aviv (IL)

Correspondence Address: MYERS WOLIN, LLC, 100 HEADQUARTERS PLAZA, North Tower, 6th Floor, MORRISTOWN, NJ, 07960-6834, US

(73) Assignee: MOOK, Tel-Aviv (IL)

(21) Appl. No.: 12/370,991

(22) Filed: Feb. 13, 2009

Related U.S. Application Data
(60) Provisional application No. 61/064,057, filed on Feb. 13, 2008.

(51) Int. Cl. A23C 9/15; A23L 2/395; B01F 13/00

(52) U.S. Cl. 426/590; 366/153.2; 366/145

(57) ABSTRACT

An apparatus and method for preparation of liquid formula from powder. The apparatus comprises a mixing spout having at least a liquid output adapted for enabling mixing of powder when the liquid is poured on the powder through the mixing spout; a first container to store the powder; and a second container to store the liquid; wherein the apparatus enabled to cause the mixing of the powder and the liquid by causing at least a portion of the liquid to flow though said mixing spout onto the powder.

### CROSS REFERENCE TO RELATED APPLICATIONS

This application claims the benefit of U.S. Provisional Application No. 61/064,057 filed on Feb. 13, 2008, and is hereby incorporated by reference in its entirety.

### FIELD OF THE INVENTION

The present invention relates generally to the mixing of a powder with a liquid. More specifically the invention relates to the preparation mixing of a powder with a liquid where the liquid is added to the powder through a mixing spout that causes the mixing of a powder with the liquid when the liquid flows through the spout.

### BACKGROUND OF THE INVENTION

Mixing a powder with a liquid is an ideal way to create a solution as the powder can be stored for relatively long periods of time and the final preparation of the required solution is done on-demand. By contrast, premixed solutions of powder and liquid, for example, premixed infant foods, have a shorter shelf life. However, having the powder separate from the liquid requires a step of preparation of the solution by properly combining the powder with the solution.

In U.S. Pat. No. 2,841,370 powder and liquid are mixed by use of a rotary contraption that has an epicycloid motion (see FIG. 2). It is noted there that “Tests have shown that the aforesaid intermittent rotary motion, the angular velocity of which varies from zero to a maximum and vice versa results in a more intimate and efficient mixing of material than would be the case if merely continuous motion were applied . . . ”. Such principles of epicycloid motion are known to be used to ensure quality mixing, in for example, mixers. A disadvantage of this contraption is in the fact that the solutions mixing is created by means of a revolving element that is inside of the solution.

U.S. Pat. No. 3,218,175 suggests another approach to the essential separation of the powder from the liquid prior to the mixing step. The powder and liquid are stored in separate compartments and when it is time for mixing a pressurized gas-borne stream of the powder is directed to the liquid stream creating a mixing zone. The disadvantages of the proposed system is that it is appropriate only for large scale manufacturing of solutions, requires the powder to be shot by using gas pressure, and requires adjustments to ensure accurate mixing of the solution per specifications, otherwise, smaller and larger lumps of ill mixed particles may occur.

Other prior art solutions suffer essentially from the same drawbacks discussed hereinabove. Their applications maybe essentially industrial therefore are not applicable for reduction into smaller scale implementations. Such systems require industrial grade hooking, e.g., the supply of gas, for proper operation. They may further require precise adjustments or significantly large volumes to operate properly. Some of the prior art implementations also involve the use of a mixing element inserted into the solution of mixed powder and liquid, thereby adding to the system costs and its maintenance, as well as reducing the sterility of the mixing process.

In a particular example, today's parents often resort sooner or later to the use of infant and toddler formulas, typically in powder form, to create liquid formula for the purpose of feeding the infant. Usually the mixing is performed just prior to the actual feeding of the infant in order to preserve the integrity and hygiene of the mixed liquid formula. Doing this with a baby crying or on one's hands brings about the need to provide a solution that is capable of mixing infant formula into a liquid form.

It would therefore be advantageous to provide a solution thereof that overcomes the stated deficiencies of prior art solutions.

### SUMMARY OF THE INVENTION

Certain embodiments of the inventions include a method for mixing a powder and a liquid. The method comprises adding a first portion of a liquid into a mixing container; adding the powder into the mixing container such that the added powder is added on top of said first portion of a liquid; and using a mixing spout to add a second portion of the liquid into said mixing container through the mixing spout, wherein adding of said second portion of the liquid through the mixing spout causing the mixing of the powder and the liquid.

Certain embodiments of the inventions further include an apparatus for mixing a powder and a liquid. The apparatus comprises a mixing spout having at least a liquid output adapted for enabling mixing of powder when the liquid is poured on the powder through the mixing spout; a first container to store the powder; and a second container to store the liquid; wherein the apparatus enabled to cause the mixing of the powder and the liquid by causing at least a portion of the liquid to flow though said mixing spout onto the powder.

Certain embodiments of the inventions also include an apparatus for mixing an infant formula. The apparatus comprises a source for providing a powder from which the infant formula is to be prepared; a source for providing water at a temperature appropriate for preparation of the infant formula; a mixing spout having at least a liquid output adapted for enabling mixing of powder when the liquid is poured on the powder through the mixing spout; wherein the apparatus enabled to cause the mixing of said infant formula and said water by causing at least a portion of said water to flow though said mixing spout onto said infant formula.

Certain embodiments of the invention also include a mixing spout. The mixing spout comprises a liquid output adapted for enabling mixing of powder when the liquid is poured on the powder through the mixing spout; a spiral path enabling flow of a powder towards the liquid output; and a stopper element at the end of the spiral path placed such that the powder being poured into the liquid is at a point that is at the end of the long symmetry line of the liquid output of the mixing spout.

### BRIEF DESCRIPTION OF THE DRAWINGS

The subject matter that is regarded as the invention is particularly pointed out and distinctly claimed in the claims at the conclusion of the specification. The foregoing and other features and advantages of the invention will be apparent from the following detailed description taken in conjunction with the accompanying drawings.

FIGS. 1(a), 1(b) and 1(c) are exemplary cross-sections of a spout and for an apparatus implemented in accordance with the disclosed invention.

FIG. 2 is a flowchart describing the steps of mixing a powder with a liquid in accordance with the principles of the invention.

FIGS. 3(a), 3(b) and 3(c) illustrating various steps of the mixing process in accordance with the principles of the invention.

FIGS. 4(a) and 4(b) are exemplary diagrams of spouts constructed in accordance with the principles of the invention.

FIGS. 5(a) and 5(b) are exemplary spout shaped in accordance with the principles of the invention.

FIG. 6 is a diagram of an exemplary spout having two liquid passages constructed in accordance with the principles of the invention.

FIG. 7 is an exemplary diagram of spouts having an essentially epicycloid opening.

FIG. 8 is a diagram of a spout having an essentially epicycloid opening further equipped with a spiral path on its outer side.

FIG. 9 is an exemplary diagram of a container equipped with a spout having an essentially epicycloid opening further equipped with a spiral path on its outer side.

### DETAILED DESCRIPTION OF THE INVENTION

It is important to note that the embodiments disclosed by the invention are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

Certain embodiments of the invention include apparatus and method for preparation of liquid formula from powder, where a liquid is dispensed through a spout having an essentially epicycloid cross section. The sprinkling of the liquid through the specially designed spout causes the powder to mix effectively with the liquid. In one embodiment, by first, putting into a container a portion of the liquid; by second, dispensing the powder formula; and, by third, dispensing the remaining quantity of the liquid through the essentially epicycloid cross-sectioned spout, mixing of the formula is achieved without the insertion of a physical mixing element into the solution, hence allowing an easy apparatus cleaning. In another embodiment a multi-channel spout directing the liquid into two or more flows is used to accomplish similar results. The principles of the invention may be used for a variety of applications such as the preparation of mixing an infant formula.

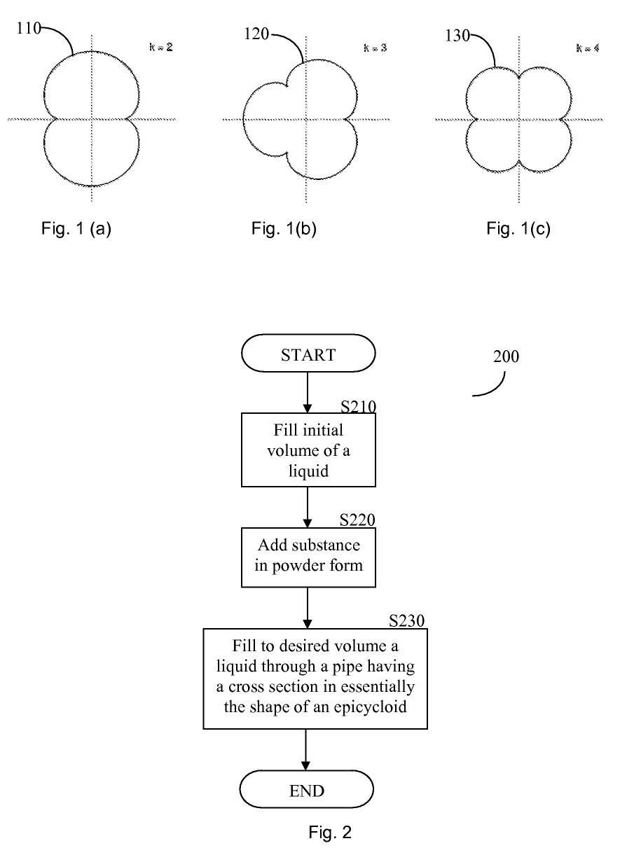

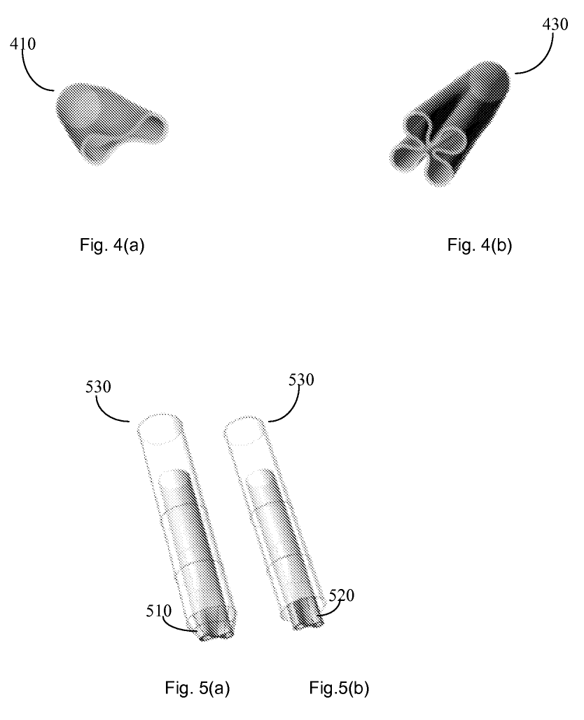

Noted in the prior art mixing using an epicycloid motion provides for a superior mixing characteristics. However, in many cases it is a disadvantage to insert a mixing element into the solution in order to perform the mixing itself. Therefore, in accordance with the principles of the disclosed invention rather than using a mixer element having an epicycloid motion, the liquid itself is provided with such motion by means of directing the liquid through a mixing spout (hereinafter may be referred to as “spout”) having an essentially epicycloid cross-section. FIGS. 1(a), 1(b) and 1(c) show three non-limiting examples of such epicycloid cross-sections labeled as 110, 120 and 130. The mathematical principles of an epicycloid are well known in the art and therefore shall not be repeated herein. However, it should be appreciated by one of ordinary skills in the art that non-perfect implementations of the epicycloid cross section are possible and hence cross-sections essentially being an epicycloid cross-section are specifically included as part of the invention. Non-limiting examples of such essentially epicycloid cross-section spouts are shown with respect of FIGS. 4(a) and 4(b). In a preferred embodiment of the invention the number of cups of the essentially epicycloid cross-section spout is even, i.e., two, four, six, and so on. For example, essentially epicycloid cross-section spouts 410 and 430 have two cups and four cups respectively.

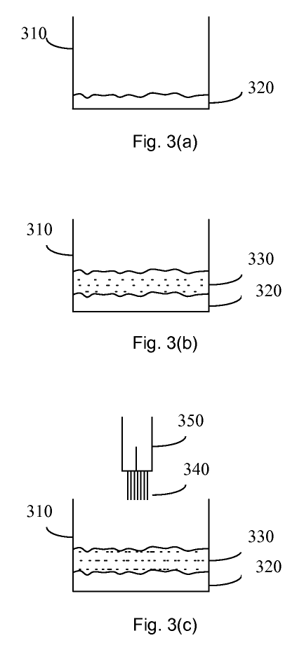

Reference is now made to FIG. 2 where an exemplary and non-limiting flowchart 200 of the mixing of a powder and a liquid implemented in accordance with the principles of the invention, is shown. The description shall be further understood with respect to FIGS. 3(a), 3(b) and 3(c) which provide an exemplary and non-limiting schematic description of the operation of the principles of the disclosed invention. In S210 an initial quantity of liquid 320 is added to a mixing container 310 (see FIG. 3(a)). In S220 a substance in the form of powder 310, for example, a powder for the preparation of infant formula, is added on top of the initial quantity of liquid 320 in the mixing container 310 (see FIG. 3(b)). In S230 a desired volume of liquid 340 is added to the mixing container 310 through a spout 350, the spout 350 having a cross-section essentially an epicycloid cross-section (see FIG. 3(c)). Adding the liquid 340 via the spout 350 causes the powder 330 and the liquid 340, including the initial quantity of liquid 320 to mix. The advantages sought by the invention are achieved as powder and liquid come into contact only at time of mixing. Furthermore, the mixing itself takes place without involving a mixing element inserted into the solution. Another advantage is the simplicity of the mixing as the liquid itself is used for the purpose of achieving the mixing. In one embodiment of the method the liquid is warm water and the powder is a powder for the preparation of an infant formula.

It should be noted that with respect to FIG. 3 a powder container (not shown), for providing the powder to the system, and a liquid container (not shown), for providing the liquid to the system, possibly at a predetermined temperature, may be used. While the use of containers of various sorts is discussed with respect to the disclosure of this invention, other sources for providing both the liquid and the powder may be used and are specifically included herein. Furthermore, a control unit (not shown) may be used to control the operation of the system in order to achieve the results of the method discussed in detail hereinabove. It should be further noted that the liquid may be further heated to a desired temperature prior to adding the liquid into the mixing container 310. This is of special value when dealing with the need to prepare an infant formula where a fairly precise temperature of the infant formula is desired to satisfy the infant's desires.

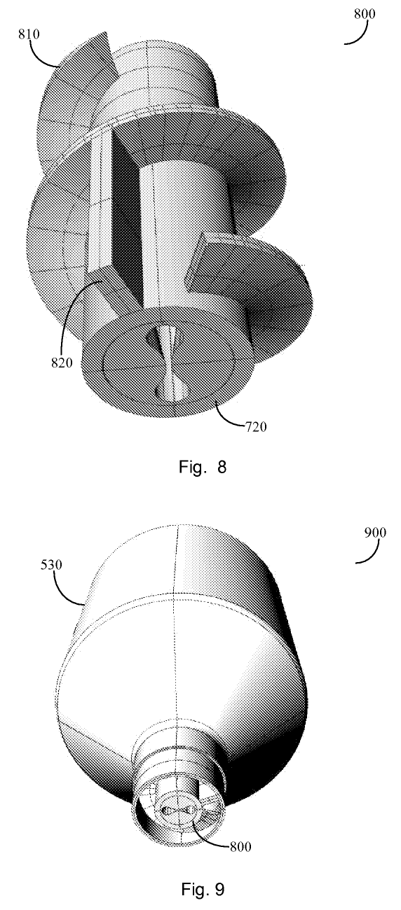

Reference is now made to FIGS. 5(a) and 5(b) where a spout is created from two elements, an external element 530, and an internal element 510 or 520, having an essentially epicycloid cross-section spouts. The liquid is poured through the elements 510 or 520. The powder can be forced to move through the element 530 essentially moving between the inner wall of element 530 and the external wall of element 510 or 520. In one embodiment of the invention, the element 530 its internal wall is further formed in the form of a screw (shown with respect of FIGS. 8 and 9 herein below) allowing the controlled downwards flow of the powder upon the turn of the external element 530 in the appropriate direction. No mixing occurs between the liquid and the powder until such time that the liquid comes into contact with the powder in the mixing container 310.

Hence, an apparatus for mixing a liquid and a powder using a spout having an essentially epicycloid cross-section to cause the powder and the liquid to effectively mix are disclosed in the invention. Furthermore, a method suggesting the pouring of an initial quantity of liquid into a mixing container, whether through a spout designed in accordance with the principles of the disclosed invention or not, followed by the addition of the powder, and then additional liquid caused to be added through a spout having an essentially epicycloid cross-section spouts is disclosed. The powder may be further added into the mixing container by means of an external element into which the spout in accordance with the invention is inserted. The powder can be moved between the internal wall of the external element and the external wall of the element having an essentially epicycloid cross-section that provides for the liquid passage. The external element may further have a screw like design internally allowing for an effective flow of the powder from its container and into the mixing container.

In one embodiment of the invention the essentially epicycloid cross-section spout is used in an apparatus for the preparation of an infant formula. It should be noted that while the internal cross-section where the liquid flows has the essentially epicycloid cross-section this is not a requirement for the external cross-section of the spout, and any other cross-section, including, but not limited to, a round cross-section are possible and shall not be considered a departure from the invention. In yet another embodiment of the invention the essentially epicycloid cross-section spout is used as part of a faucet of a dispensing mechanism designed to dispense liquid.

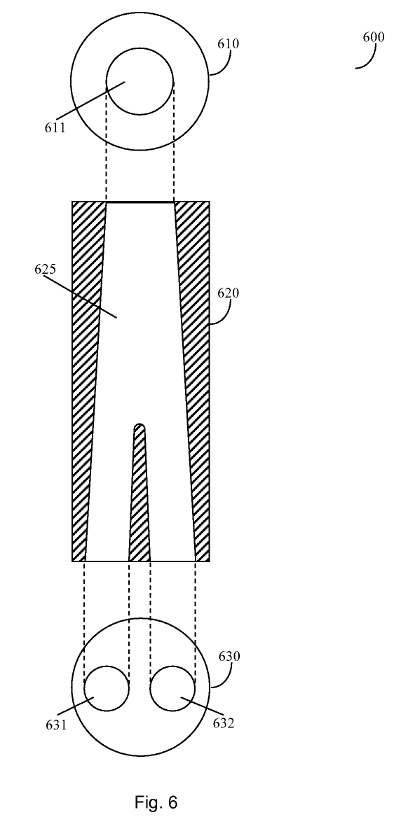

Reference is now made to FIG. 6 where an exemplary and non-limiting design of a spout 600 having two output liquid passages 631, 632 is shown. Specifically, the mixing spout (also referred to herein as “spout”) may replace the spout described in detail hereinabove to provide similar mixing results. For its proper operation, the spout 600 in accordance with the method of FIG. 2, where in S230 the essentially epicycloid cross-section of the spout is replaced by the spout 600 having a plurality of output liquid passages.

Referring back to FIG. 6, a cross-section 620 is shown with a liquid passage 625 that is capable of accepting a liquid at its input 625, also shown in the top view 610, and outputting the liquid through both the output liquid passages 631 and 632, also shown in the bottom view 630. While two liquid passages are shown with respect to FIG. 6 it should be noted that a plurality of such passages may be used as long as the flow of liquid is significant enough to enable the mixing envisioned with respect to the disclosed invention. Operation wise the spout 600 is used such that first an initial volume of liquid is added to a mixing container, possibly through the spout 600, then powder is added, and finally, the rest of the required volume of liquid is added through spout the 600. In another embodiment of the invention spout the 600 is used as part of a faucet of a dispensing mechanism designed to dispense liquid.

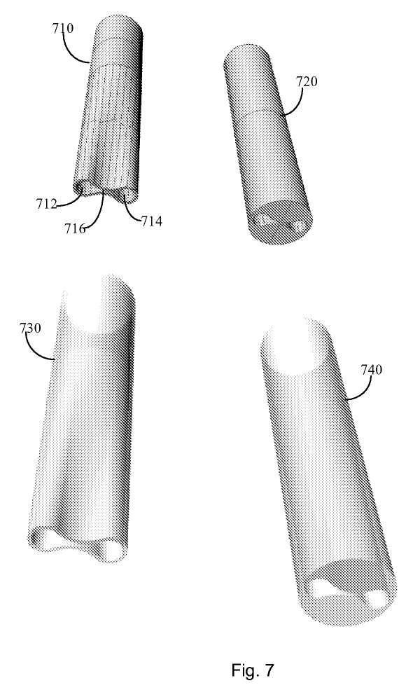

Reference is now made to FIG. 7 that shows exemplary and non-limiting spouts 710, 720, 730, and 740 all having openings that are essentially in the form of an epicycloid. Attention is specifically drawn to the spout 710 having two wide opening portions 712 and 714 separated by a narrower gap 716. While not exactly a mathematical epicycloid, this essentially epicycloid opening also provides the benefits of the disclosed invention and therefore should be considered an integral part of it. Further to be noted that regardless of the difference in the design specifics of the spouts 710, 720, 730 and 740, they all have an opening which is an essentially an epicycloid and therefore form part of the disclosed invention.

Referring now to FIG. 8 there is shown a contraption 800 comprising a spout 720 having an essentially epicycloid opening and that is further equipped with a spiral path 810 on its outer side. The spiral path 810 is the path over which the powder is moved towards the spout opening at the bottom of the spout 720. The spout 720 is preferably equipped with a stopper 820 that forces the powder gliding down the spiral path 810 to pour into the liquid 320 at a position which is at the edge of the long symmetry axis of the epicycloid opening of the spout 720. It has been demonstrated in numerous experiments made by the applicants that pouring the powder into the liquid at that point provides for better mixing results. In FIG. 9 there is shown a system 900 comprising of the contraption 800 that is placed inside a canister (also referred to hereinabove as an external element) 530 having a round spout at it end to fit the end portion of contraption 800 as shown in FIG. 9. Canister 530 may be filled with the powder and when contraption 800 turns such that the spiral provides a downward direction the powder will pour as described hereinabove.

Embodiments of the disclosed invention include, without limitations, a variety of spouts implemented in faucets and taps used in a variety of equipment.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

1. A method for mixing a powder and a liquid comprising:
adding a first portion of a liquid into a mixing container;
adding the powder into the mixing container such that the added powder is added on top of said first portion of a liquid; and
using a mixing spout to add a second portion of the liquid into said mixing container through the mixing spout, wherein adding of said second portion of the liquid through the mixing spout causing the mixing of the powder and the liquid.

2. The method of claim 1, wherein said mixing spout has one of:
a liquid output cross-section that is essentially an epicycloid;
a liquid output cross-section having two or more liquid flow passages.

3. The method of claim 2, wherein adding the powder into the mixing container further comprising:
pouring the powder into the liquid at a point that is at the end of the long symmetry line of the liquid output of the mixing spout.

4. The method of claim 1, wherein said liquid is water and said powder is a powder for the preparation of infant formula.

5. The method of claim 1, wherein said adding a first portion of the liquid is performed through said mixing spout.

6. The method of claim 1, further comprising:
bringing the liquid to a desired temperature.

7. An apparatus for mixing a powder and a liquid comprising:
a mixing spout having at least a liquid output adapted for enabling mixing of powder when the liquid is poured on the powder through the mixing spout;
a first container to store the powder; and
a second container to store the liquid;
wherein the apparatus enabled to cause the mixing of the powder and the liquid by causing at least a portion of the liquid to flow though said mixing spout onto the powder.

8. The apparatus of claim 7, wherein said liquid output of said mixing spout has essentially an epicycloid cross-section or has two or more liquid flow passages.

9. The apparatus of claim 8, wherein said mixing spout further comprises:
a spiral path enabling flow of the powder towards the liquid output; and
a stopper element at the end of the spiral path placed such that the powder being poured into the liquid is at a point that is at the end of the long symmetry line of the liquid output of the mixing spout.

10. The apparatus of claim 8, wherein said essentially epicycloid cross-section having an even number of cups.

11. The apparatus of claim 7, further comprising:
a control unit enabled to cause the adding of an initial quantity of the liquid to a mixing container.

12. The apparatus of claim 11, wherein said control unit is enabled to add the powder subsequent to said adding an initial quantity of the liquid.

13. The apparatus of claim 12, wherein said control unit is enabled to add said at least a portion of the liquid subsequent to said adding the powder.

14. The apparatus of claim 7, further comprising:
an essentially elongated tube surrounding said mixing spout, said essentially elongated tube designed to enable the flow of the powder between the internal wall of said essentially elongated tube and the external wall of said mixing spout.

15. The apparatus of claim 7, further comprising:
a control unit enabled to bring the liquid to a desired temperature.

16. An apparatus for mixing an infant formula comprising:
a source for providing a powder from which the infant formula is to be prepared;
a source for providing water at a temperature appropriate for preparation of the infant formula;
a mixing spout having at least a liquid output adapted for enabling mixing of powder when the liquid is poured on the powder through the mixing spout;
wherein the apparatus enabled to cause the mixing of said infant formula and said water by causing at least a portion of said water to flow though said mixing spout onto said infant formula.

17. An apparatus for dispensing a liquid comprising a mixing spout, said mixing spout having a liquid output adapted for enabling mixing of powder when the liquid is poured on the powder through the mixing spout.

18. A mixing spout, comprising:
a liquid output adapted for enabling mixing of powder when the liquid is poured on the powder through the mixing spout;
a spiral path enabling flow of a powder towards the liquid output; and
a stopper element at the end of the spiral path placed such that the powder being poured into the liquid is at a point that is at the end of the long symmetry line of the liquid output of the mixing spout.

19. The mixing apparatus of claim 18, wherein the liquid output has essentially an epicycloid cross-section or has two or more liquid flow passages.

20. The mixing apparatus of claim 19, wherein the essentially epicycloid cross section having an even number of cups.
